(19) United States
(12) Patent Application Publication
(10) Pub. No.: US 2015/0121452 A1
(43) Pub. Date: Apr. 30, 2015

(54) SECURITY DESIGN DEVICE AND SECURITY DESIGN METHOD

(71) Applicant: NEC Corporation, Minato-ku, Tokyo (JP)

(72) Inventor: Jun Koizumi, Tokyo (JP)

(21) Appl. No.: 14/397,612

(22) PCT Filed: Apr. 22, 2013
(86) PCT No.: PCT/JP2013/002696

§ 371 Date: Oct. 28, 2014

(30) Foreign Application Priority Data
May 7, 2012 (JP) 2012-105998

(51) Int. Cl. G06F 21/57

(52) U.S. Cl. CPC G06F 21/57; G06F 2221/034
USPC 726/1

(57) ABSTRACT

The invention provides a security design device that, even when a core configuration element implementing a security function has become unusable, enables maintenance of security that existed before the loss of the core configuration element. The security design device: in correspondence with a configuration change of a first configuration element, extracts a security requirement model; and if the first configuration element is the core configuration element, for a second configuration element for which the security function was implemented by means of the first configuration element, generates the security requirement model without using the first configuration element, said security requirement model implementing the same security function as when the first configuration is used.

### REFERENCE TO RELATED APPLICATION

The present application is a National Stage Entry of PCT/JP2013/002696 filed Apr. 22, 2013, which is based on and claims the benefit of the priority of Japanese Patent Application No. 2012-105998, filed on May 7, 2012, the disclosures of all of which are incorporated herein their entirety by reference.

### TECHNICAL FIELD

The present invention relates to a security design device, a security design method and a program thereof which determine a method for implementing a system.

### BACKGROUND ART

Various related arts to determine a method for implementing a system are known.

For example, a patent literature 1 discloses an example of a security operation management system. The security operation management system described in the patent literature 1 includes the following configuration. Firstly, a state prescript storing means holds a state prescript which prescribes a desirable security state. Secondly, when a state transition means is notified of a current state of a system, the state transition means determines a target state, which is corresponding to the current state, on the basis of the state prescript. Thirdly, an action determining means carries out an action so that the present state may transit to the target state. The patent literature 1 claims that the security operation management system, which has the above-mentioned configuration, can implement comprehensively and consistently a security measure which can cope with a state change of the system.

Moreover, a patent literature 2 discloses an example of a security risk management system. The security risk management system described in the patent literature 2 includes the following configuration. Firstly, a risk analysis means analyzes information, which indicates a current system state of a target system, by use of a risk model, and then calculates a risk value. Secondly, when the risk value exceeds an admissible range, a measure generating means carries out analysis by use of the risk model and a measure model, and generates some proposal-based measures for reducing a security risk. Thirdly, a proposal-based measure selecting means selects a proposal-based measure on the basis of a degree of risk reduction and various restrictions. The patent literature 2 claims that it is possible to show an optimum proposal-based measure by use of the security risk management system, which has the above-mentioned configuration, in consideration of the various restrictions which are caused the target system.

### CITATION LIST

### Patent Literature

[PTL 1] International Publication Number WO 2009/037897
[PTL 2] International Publication Number WO 2008/004498

### SUMMARY OF INVENTION

### Technical Problem

However, the art which is disclosed in the preceding technical literature mentioned above has a problem that there is a case that, in the case that a first configuration device becomes unusable, it is impossible to maintain security of a second configuration element. The first configuration element is a core configuration element for implementing a security function. The second configuration element is a configuration element whose security function is implemented by the first configuration element.

Here, a case that a function of the first configuration element is lost is corresponding to a case that a fault is caused the first configuration element, a case that maintenance is carried out to the first configuration element, or the like.

The reason will be shown in the following.

That is, the reason is that, since the art which the patent literatures 1 and 2 disclose does not assume specifically the loss of the core configuration element for implementing the security function, it is impossible for the art to generate a measure to cope with such the case mentioned above.

An object of the present invention is to provide a security design device, a security design method and a program thereof which solve the problem mentioned above.

### Solution to Problem

A security design device according to one aspect of the present invention includes:

a model change judging unit which receives configuration change information, which includes identification information of a first configuration element included in a target system, from the outside, and

for extracting a security requirement model, which is corresponding to the identification information of the first configuration element, from a set of security requirement models including one or more security requirement model records including at least configuration element identification information, security function identification information, security function implementation method identification information and security work element identification information which are related to a security function of the target system, and for outputting the extracted security requirement model, and

for judging, by use of configuration element classification information indicating that a configuration element is ‘core configuration element’, which implements a security function of another configuration element, or ‘not’, in an implementation method of a security function which is specified by the security function identification information and the security function implementation method identification information, whether the first configuration element is ‘core configuration element’, which implements a security function of a second configuration element other than the first configuration element, or ‘not’ in the extracted security requirement model, and for outputting the judgment result;

a changed model generating unit which uses information, which indicates a relation among identification information, an implementation method, a configuration element classification and a security work element of the security function, and information on a configuration element of the target system, and for generating a changed security requirement model corresponding to a security requirement model which, without using the first configuration element, implements a security function, which is the same as when the first configuration element is used, for the second configuration element, and for outputting the changed security requirement model which is generated, in the case that the judgment result of the model change judging unit is that the first configuration element is ‘core configuration element’; and

a work extracting unit which extract the security work element of the changed security requirement model and for outputting the extracted security work element.

A security design method according to one aspect of the present invention is the method wherein a computer:

receives configuration change information, which includes identification information of a first configuration element included in a target system, from the outside;

extracts a security requirement model, which is corresponding to the identification information of the first configuration element, from a set of security requirement models including one or more security requirement model records including at least configuration element identification information, security function identification information, security function implementation method identification information and security work element identification information which are related to a security function of the target system, and outputting the extracted security requirement model;

judges, by use of configuration element classification information indicating that a configuration element is ‘core configuration element’, which implements a security function of another configuration element, or ‘not’, in an implementation method of a security function which is specified by the security function identification information and the security function implementation method identification information, whether the first configuration element is ‘core configuration element’, which implements a security function of a second configuration element other than the first configuration element, or ‘not’ in the extracted security requirement model, and outputting the judgment result;

uses information, which indicates a relation among identification information, an implementation method, a configuration element classification and a security work element of the security function, and information on a configuration element of the target system, and generating a changed security requirement model corresponding to a security requirement model which, without using the first configuration element, implements a security function, which is the same as when the first configuration element is used, for the second configuration element, and outputting the changed security requirement model which is generated, in the case that the first configuration element is ‘core configuration element’; and

extracts the security work element of the changed security requirement model, and outputting the extracted security work element.

A non-transitory computer-readable recording medium according to one aspect of the present invention records a program to make a computer execute process of:

receiving configuration change information, which includes identification information of a first configuration element included in a target system, from the outside;

extracting a security requirement model, which is corresponding to the identification information of the first configuration element, from a set of security requirement models including one or more security requirement model records including at least configuration element identification information, security function identification information, security function implementation method identification information and security work element identification information which are related to a security function of the target system, and outputting the extracted security requirement model;

judging, by use of configuration element classification information indicating that a configuration element is ‘core configuration element’, which implements a security function of another configuration element, or ‘not’, in an implementation method of a security function which is specified by the security function identification information and the security function implementation method identification information, whether the first configuration element is ‘core configuration element’, which implements a security function of a second configuration element other than the first configuration element, or ‘not’ in the extracted security requirement model, and outputting the judgment result;

using information, which indicates a relation among identification information, an implementation method, a configuration element classification and a security work element of the security function, and information on a configuration element of the target system, and generating a changed security requirement model corresponding to a security requirement model which, without using the first configuration element, implements a security function, which is the same as when the first configuration element is used, for the second configuration element, and outputting the changed security requirement model which is generated, in the case that the first configuration element is ‘core configuration element’; and

extracting the security work element of the changed security requirement model, and outputting the extracted security work element.

### Advantageous Effects of Invention

The present invention has an advantage that, even when a first configuration element (a core configuration element) which is a core for implementing a security function has become unusable, it is possible to maintain security which existed before the loss of the core configuration element.

### BRIEF DESCRIPTION OF DRAWINGS

FIG. 1 is a block diagram showing a configuration of a security design device according to a first exemplary embodiment.

FIG. 2 is a diagram showing an example of a security requirement model storing unit in the first exemplary embodiment.

FIG. 3 is a diagram showing an example of configuration element classification information in the first exemplary embodiment.

FIG. 4 is a diagram showing an example of security function information in the first exemplary embodiment.

FIG. 5 is a diagram showing an example of system configuration element information in the first exemplary embodiment.

FIG. 6 is a block diagram showing a hardware configuration of a computer which implements the security design device according to the first exemplary embodiment.

FIG. 7 is a flowchart showing an outline of an operation of the security design device in the first exemplary embodiment.

FIG. 8 is a block diagram showing a configuration of a security design device according to a second exemplary embodiment.

FIG. 9 is a block diagram showing a configuration of a security design device according to a third exemplary embodiment.

FIG. 10 is a diagram showing an example of security function information in the third exemplary embodiment.

FIG. 11 is a block diagram showing a configuration of a security design device according to a fourth exemplary embodiment.

FIG. 12 is a flowchart showing an outline of an operation of the security design device in the fourth exemplary embodiment.

FIG. 13 is a block diagram showing a configuration of a security design device according to a fifth exemplary embodiment.

FIG. 14 is a block diagram showing a configuration of a security design device according to a sixth exemplary embodiment.

FIG. 15 is a diagram showing an example of a changed security requirement model storing unit in the sixth exemplary embodiment.

FIG. 16 is a diagram showing an example of the changed security requirement model storing unit in the sixth exemplary embodiment.

FIG. 17 is a block diagram showing a configuration of a security design device according to a seventh exemplary embodiment.

### DESCRIPTION OF EMBODIMENTS

An exemplary embodiment for carrying out the present invention will be described in detail with reference to a drawing. Here, in each exemplary embodiment which is described in each drawing and the specification, a code of one configuration element, which has a common function with another configuration element, is the same as a code of the other configuration element.

### First Exemplary Embodiment

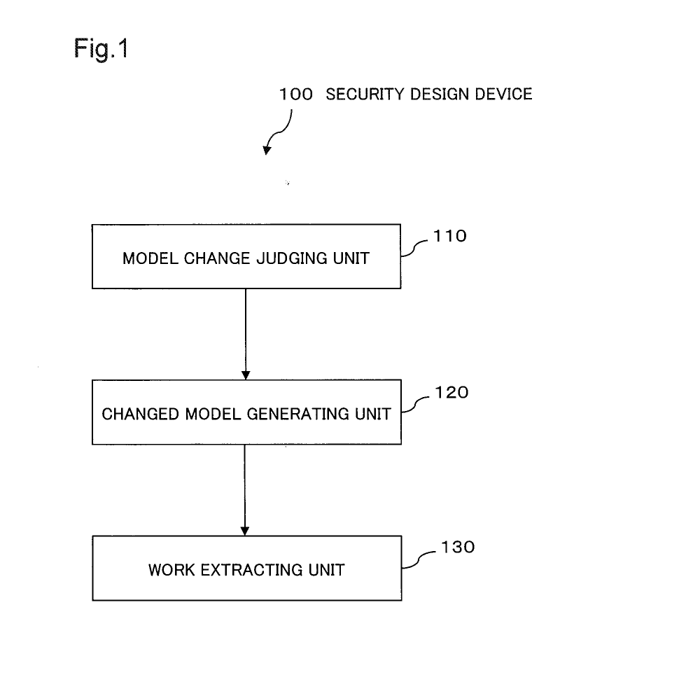

FIG. 1 is a block diagram showing a configuration of a security design device 100 according to a first exemplary embodiment of the present invention.

Referring to FIG. 1, the security design device 100 according to the exemplary embodiment includes a model change judging unit 110, a changed model generating unit 120 and a work extracting unit 130. Here, a configuration element shown in FIG. 1 indicates a configuration element not in an unit of hardware but in an unit of function.

===Model Change Judging Unit 110===

The model change judging unit 110 receives configuration change information from the outside. The configuration change information includes identification information of a first configuration element which is included in a target system. The configuration change information is information which indicates that an operational configuration of the target system has been changed (for example, one of apparatuses which are included in the target system has stopped). Here, the configuration change information may be information which indicates that the operational configuration of the target system will be changed. Here, the target system is a target for security design which is carried out by the security design device 100 of the exemplary embodiment.

Moreover, the model change judging unit 110 extracts a security requirement model, which is corresponding to the identification information of the first configuration element, out of a set of security requirement models, and outputs the extracted security requirement model.

===Security Requirement Model===

Here, the security requirement model will be described. In correspondence with each of one or more security functions in the target system, the security requirement model defines a requirement for implementing the security function.

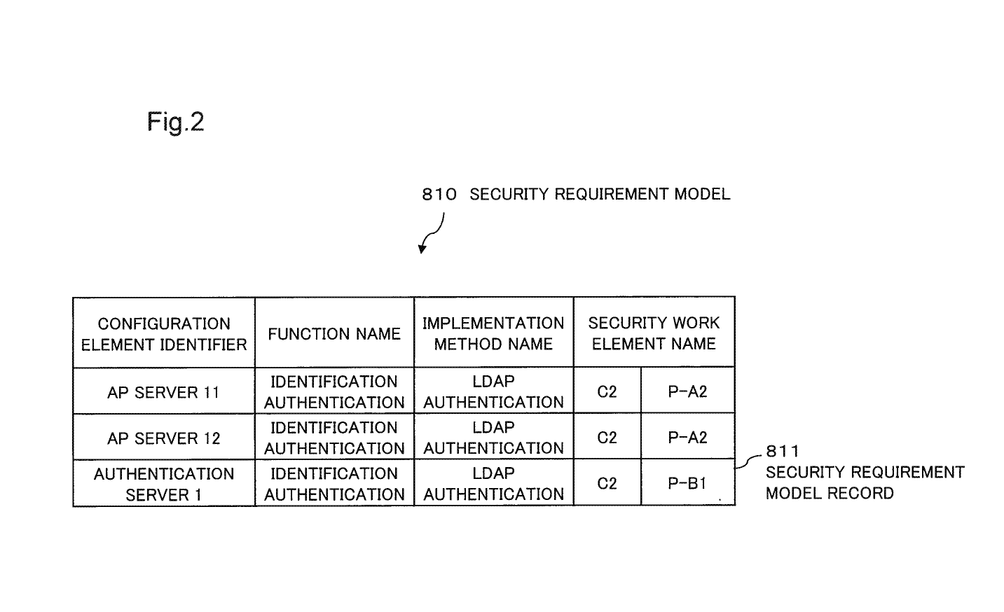

FIG. 2 is a diagram showing an example of a security requirement model 810. As shown in FIG. 2, the security requirement model 810 includes one or more security requirement model records 811. The security requirement model record 811 includes at least a configuration element identifier, a function name, an implementation method name and a security work element name which are related to the security function of the target system.

The configuration element identifier is an identifier of a configuration element which is related to the security requirement model.

The function name is identification information which specifies the security function defined by the security requirement model. Here, the function name is also called security function identification information.

The implementation method name is identification information to specify an implementation method which implements the security function defined by the security requirement model. The implementation method name is also called security function implementation method identification information.

The security work element name is identification information to specify a work element which is carried out when implementing the security function, which is specified by the function name, with the implementation method which is specified by the implementation method name. The security work element name is also called security work element identification information. For example, the work element includes a work element which is corresponding to both of the security function specified by the function name, and the implementation method specified by the implementation method name, and a work element which is corresponding to the configuration element indicated by the configuration element identifier.

For example, a work element ‘C2’ means addition of an authentication domain, registration of identification authentication information of an AP (Application) server (not shown in the figure), or the like for adding newly an AP server to an authentication server (not shown in the figure) or changing an AP server in the authentication server.

For example, a work element ‘P-A2’ means setting an IP (Internet Protocol) address of an authentication server to an AP server. Or, the work element ‘P-A2’ may mean setting an authentication domain to an AP server when changing from local authentication to LDAP (Lightweight Directory Access Protocol) authentication.

The above is an explanation on the security requirement model 810.

===Continuation of Model Change Judging Unit 110===

Returning to the model change judging unit 110, the explanation will be continued in the following.

By use of configuration element classification information, the model change judging unit 110 judges whether the first configuration element is a core configuration element in the extracted security requirement model. The core configuration element is a configuration element which implements a security function of a second configuration element other than the first configuration element. Then, the model change judging unit 110 outputs the judgment result.

===Configuration Element Classification Information===

Here, the configuration element classification information will be described.

The configuration element classification information indicates whether a specific configuration element is the core configuration element, which implements a security function of another configuration element, or not in a specific implementation method for implementing a specific security function.

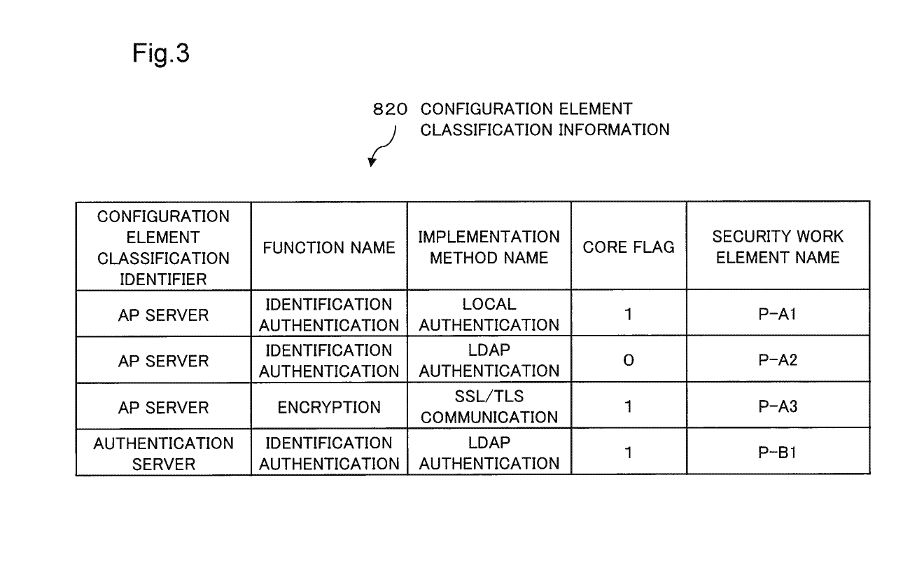

FIG. 3 is a diagram showing an example of configuration element classification information 820. As shown in FIG. 3, the configuration element classification information 820 includes at least the configuration element classification identifier, the function name, the implementation method name and a core flag. Moreover, the configuration element classification information 820 includes the security work element name which is corresponding to the configuration element classification identifier. The configuration element classification information 820 including the security work element name is a piece of information which indicates a relation among the identification information, the implementation method, the configuration element classification and the security work element of the security function.

The configuration element classification identifier indicates a classification of the configuration element. Here, it is assumed that the configuration element identifier (for example, AP server 11) shown in FIG. 2 is assigned so as to include the configuration element classification identifier (AP server) shown in FIG. 3. Accordingly, the security design device 100 can associate the configuration element identifier shown in FIG. 2 and the configuration element classification identifier shown in FIG. 3. Here, a relation between the configuration element identifier shown in FIG. 2 and the configuration element classification identifier shown in FIG. 3 is not limited to the above-mentioned relation. For example, the configuration element classification identifier may be included in the security requirement model record. Moreover, a relation table which indicates the relation between the configuration element identifier shown in FIG. 2 and the configuration element classification identifier shown in FIG. 3 may be held by a means which is not shown in the figure.

The function name and the implementation method name are the same as the function name and the implementation method name shown in FIG. 2 respectively.

The core flag indicates whether a configuration element, whose classification is indicated by the configuration element classification identifier, is the core configuration element or not in the implementation method for implementing the security function which is specified by the function name and the implementation method name. The core configuration element is a configuration element which implements a security function of another configuration element. Here, the core flag indicates to be ‘core configuration element’ in the case that the core flag is ‘1’, and indicates to be ‘not’ in the case of ‘0’.

The security work element name indicates a work element which is corresponding to the configuration element whose classification is indicated by the configuration element classification identifier.

===Changed Model Generating Unit 120===

In the case that a judgment result of the model change judging unit 110 is ‘core configuration element (first configuration element is the core configuration element)’, the changed model generating unit 120 generates a changed security requirement model by use of the security function information and information on the configuration element of the target system. Then, the changed model generating unit 120 outputs the changed security requirement model which is generated. Here, the changed security requirement model is a security requirement model which, without using the first configuration element, implements a security function, which the same as when the first configuration is used, for the second configuration element.

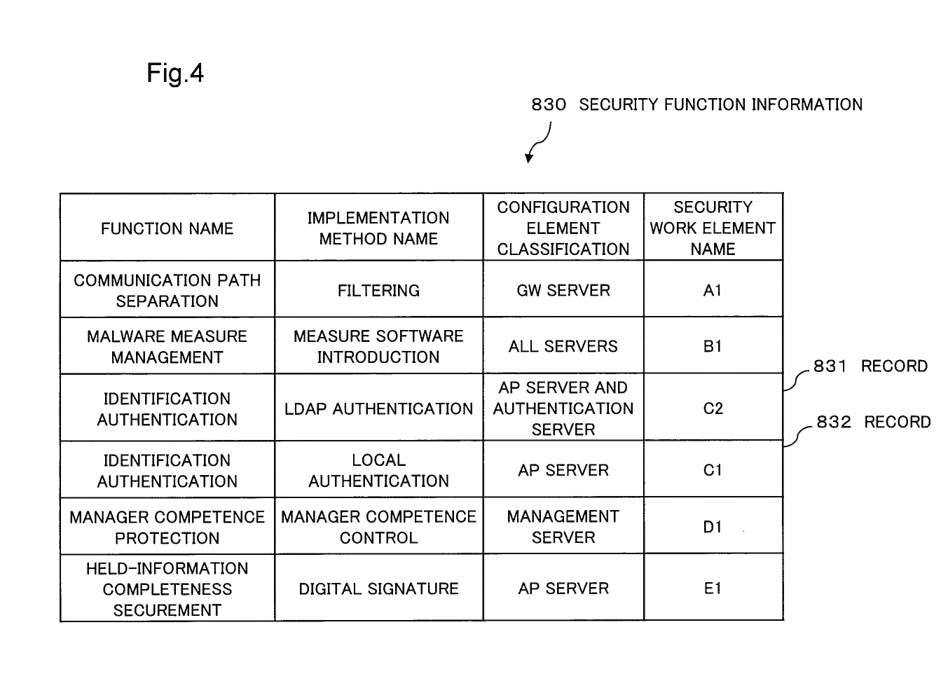

FIG. 4 is a diagram showing an example of security function information 830. As shown in FIG. 4, the security function information 830 indicates one or more configuration element classification identifiers which are corresponding to the function name and the implementation method name. Moreover, the security function information 830 indicates the security work element name which is corresponding to the function name and the implementation method name. That is, the security function information 830 is a piece of information which indicates a relation among the identification information, the implementation method, the configuration element classification and the security work element of the security function.

The function name and the implementation method name are the same as the function name and the implementation method name shown in FIG. 2 respectively.

The configuration element classification designates the configuration element classification identifier shown in FIG. 3.

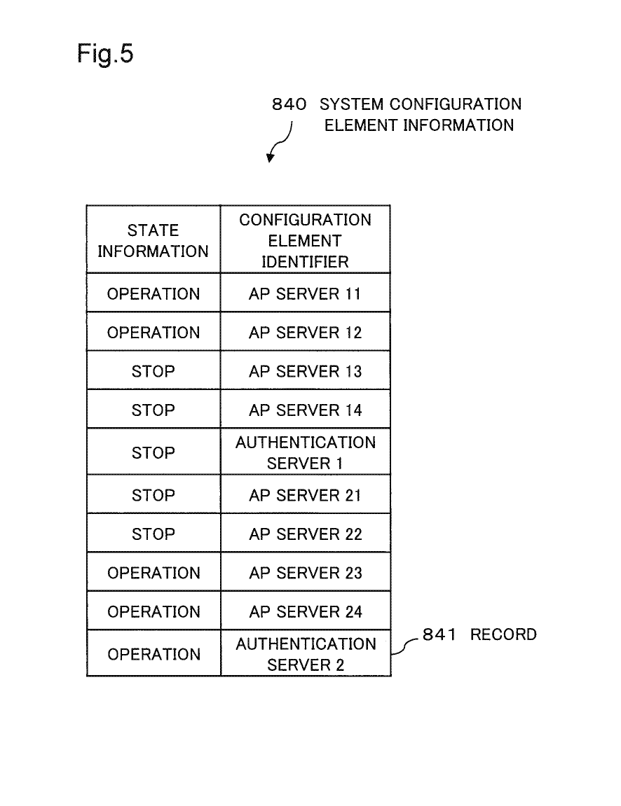

FIG. 5 is a diagram showing an example of information on the configuration element of the target system. As shown in FIG. 5, system configuration element information 840 includes at least the configuration element identifier and state information.

The configuration element identifier is the same as the configuration element identifier shown in FIG. 2.

A state information flag indicates whether the configuration element designated by the configuration element identifier is in an operation state (usable) or in a stop state (unusable).

===Work Extracting Unit 130===

The work extracting unit 130 extracts a security work element which is included in the changed security requirement model generated by the changed model generating unit 120.

The above is a description on each configuration element of the security design device 100 in an unit of function.

Next, a configuration element of the security design device 100 in an unit of hardware will be described.

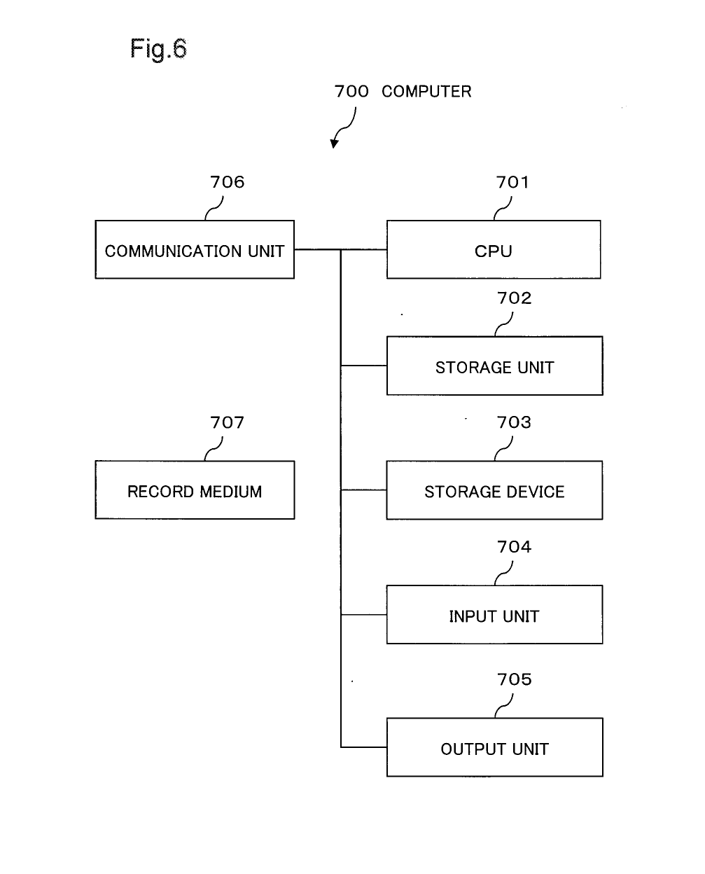

FIG. 6 is a diagram showing a hardware configuration of a computer 700 which implements the security design device 100 in the exemplary embodiment.

As shown in FIG. 6, the computer 700 includes CPU (Central Processing Unit) 701, a storage unit 702, a storage device 703, an input unit 704, an output unit 705 and a communication unit 706. Furthermore, the computer 700 includes a recording medium (or storage medium) 707 which is supplied from the outside. The recording medium 707 may be a non-volatile recording medium which stores information non-transitory.

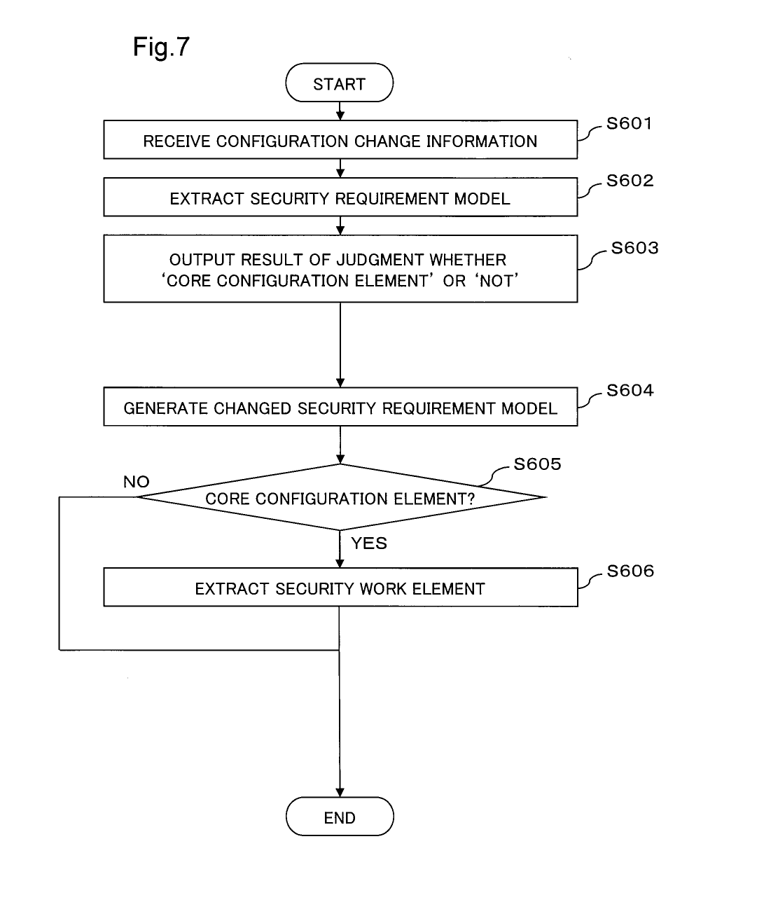

CPU 701 controls a whole of operation of the computer 700 by working the operating system (not shown in the figure). Moreover, CPU 701 reads a program and data, for example, from the recording medium 707 which is attached to the storage device 703, and writes the read program and data in the storage unit 702. Here, the program is, for example, a program which makes the computer 700 execute an operation described in a flowchart shown in FIG. 7 which will be described later.

Then, CPU 701 executes various processes according to the read program or on the basis of the read data as the model change judging unit 110, the changed model generating unit 120 and the work extracting unit 130.

Here, CPU 701 may download the program and the data from an external computer (not shown in the figure), which is connected with a communication network (not shown in the figure), to the storage unit 702.

The storage unit 702 stores the program and the data. The storage unit 702 may stores the security requirement model 810, the configuration element classification information 820, the security function information 830, system configuration element information 840 and the security work element which is extracted by the work extracting unit 130.

The storage unit 703, which is, for example, an optical disc, a flexible disc, a magnetic optical disc, an external hard disk or a semiconductor memory, includes the recording medium 707. The storage device 703 records the program so that the program may be computer-readable. Moreover, the storage device 703 may record the data so that the data may be computer-readable. The storage device 703 may store the security requirement model 810, the configuration element classification information 820, the security function information 830 and the system configuration element information 840.

The input unit 704 is implemented, for example, by a mouse, a keyboard, a built-in key button or the like and is used for an input operation. The input unit 704 is not limited to the mouse, the keyboard, the built-in key button. The input unit 704 may be, for example, a touch panel, an accelerometer, a gyro sensor, a camera or the like.

The output unit 705 is implemented, for example, by a display, and is used for checking an output. The output unit 705 may be included as a part of the operational extraction unit 130 and display the security work element.

The communication unit 706 implements an interface with an external apparatus or an external system (for example, target system). The communication unit 706 is included as a part of the model change judging unit 110, and receives configuration change information. Moreover, the communication unit 706 may receive the security requirement model 810, the configuration element classification information 820, the security function information 830 and the system configuration element information 840. Furthermore, the communication unit 706 may be included as a part of the work extracting unit 130, and send the extracted security work element.

As described above, a block of the security design device 100 in an unit of function unit shown in FIG. 1 is implemented by the computer 700 which has the hardware configuration shown in FIG. 6. However, a means, with which the computer 700 is equipped, for implementing each unit is not limited to the above. That is, the computer 700 may be implemented by one apparatus which has physical combination internally, or by a plurality of apparatuses which are separated each other physically and connected each other through wire or wireless communication.

Here, the recording medium 707 which records a code of the above-mentioned program may be supplied to the computer 700, and CPU 701 may read and carry out the code of the program which is stored in the recording medium 707. Or, CPU 701 may store the code of the program, which is stored in the recording medium 707, in the storage unit 702 and/or the storage device 703. That is, the exemplary embodiment includes an exemplary embodiment of the recording medium 707 which stores transitory or non-transitory the program (software) executed by the computer 700 (CPU 701).

The above is a description on each configuration element of the computer 700, which implements the security design device 100 in the exemplary embodiment, in an unit of hardware.

Next, an operation of the exemplary embodiment will be described in detail with reference to FIG. 1 to FIG. 7.

FIG. 7 is a flowchart showing the operation of the exemplary embodiment. Here, processes defined in the flowchart may be carried out on the basis of program control, which is carried out by the CPU 701 mentioned above. Moreover, a step name of the process is denoted as a symbol like S601.

The model change judging unit 110 receives the configuration change information (for example, ‘authentication server 1: stop’) (S601).

Next, the model change judging unit 110 extracts a security requirement model which is corresponding to the identification information of the configuration element (for example, ‘authentication server 1’) included in the configuration change information, and outputs the extracted security requirement model (S602). Here, hereinafter, ‘identification information of configuration element included in configuration change information’ is called ‘changed configuration element identification information’. Moreover, the security requirement model is, for example, the security requirement model 810 which includes the security requirement model record 811 of the authentication server 1 shown in FIG. 2.

Next, with reference to the configuration element classification information (for example, configuration element classification information 820 shown in FIG. 3), the model change judging unit 110 judges on the basis of the core flag whether the configuration element indicated by the changed configuration element identification information is ‘core configuration element’ or ‘not’, and outputs the judgment result (S603). For example, with reference to the configuration element classification information 820 shown in FIG. 3, the model change judging unit 110 judges that the configuration element indicated by ‘authentication server 1’ (that is, corresponding configuration element classification identifier is ‘authentication server’) is ‘core configuration element’. Then, the model change judging unit 110 outputs the judgment result (for example, ‘authentication server 1: core configuration information’).

Next, the changed model generating unit 120 generates a changed security requirement model on the basis of the received judgment result by use of the security function information 830 and the system configuration element information 840, and outputs the changed security requirement model which is generated (S604). Here, the changed model generating unit 120 may carry out no process in the case that the judgment result which the model change judging unit 110 outputs is ‘not’.

Next, a specific example of S604 will be described.

### First Specific Example

With reference to the security function information 830, the changed model generating unit 120 acquires a record 831 including a function name which is identical with the function name included in the security requirement model 810.

Next, with reference to the system configuration element information 840, the changed model generating unit 120 judges that the judgment result is ‘authentication server 1: core configuration information’ and that the configuration element classification of the record 831 includes the configuration element classification identifier of ‘authentication server’. Continuously, the changed model generating unit 120 acquires a record 841 which indicates that the configuration element classification identifier is ‘authentication server’ and the state information is ‘operation’ (that is, other than ‘authentication server 1’).

Next, the changed model generating unit 120 generates a changed security requirement model on the basis that the implementation method name included in the record 831 is ‘LDAP authentication’. The changed security requirement model is a changed security requirement model whose configuration element identifier is changed from ‘authentication server 1’, which is included in the security requirement model 810 as the configuration element identifier, to ‘authentication server 2’.

Next, the changed model generating unit 120 outputs the changed security requirement model which is generated.

### Second Specific Example

With reference to the security function information 830, the changed model generating unit 120 acquires a record 832 including a function name which is identical with the function name included in the security requirement model 810.

Next, the changed model generating unit 120 generates a changed security requirement model on the basis that the configuration element classification identifier included in the record 832 is only ‘AP server’. The changed security requirement model is a changed security requirement model which is acquired by deleting the security requirement model record 811, whose configuration element identifier is ‘authentication server 1’, from the security requirement model 810.

Next, on the basis that the implementation method name included in the record 832 is ‘local authentication’, the changed model generating unit 120 generates a changed security requirement model whose implementation method name is replaced with ‘local authentication’.

Furthermore, on the basis that the security work element name included in the record 832 is ‘C1’, the changed model generating unit 120 generates a changed security requirement model whose security work element name is changed from ‘C2’ to ‘C1’.

Furthermore, on the basis that the implementation method name is replaced, the changed model generating unit 120 extracts a security work element name ‘P-A1’ with reference to the configuration element classification information 820. The security work element name ‘P-A1’ is corresponding to ‘AP server’ of the configuration element classification identifier, ‘identification authentication’ of the function name and ‘local authentication’ of the implementation method name. Continuously, in consideration that the extracted security work element name is ‘P-A1’ and that the security work element name of the changed security requirement model is ‘P-A2’, the changed model generating unit 120 generates a changed security requirement model whose security work element name is changed from ‘P-A2’ to ‘P-A1’.

Next, the changed model generating unit 120 outputs the changed security requirement model.

The above is a description on the second specific example.

Here, the second specific example is not limited to the above-mentioned example. The changed model generating unit 120 may acquire required information with an optional method and generate a changed security requirement model. Accordingly, information indicating the relation among the identification information, the implementation method, the configuration element classification and the security work element of the security function, and information on the configuration element of the target system may be held or provided in an optional form. For example, the security design device 100 may hold the system configuration element information in the storage unit 702. In this case, for example, the model change judging unit 110 may update the state information on the basis of the received configuration change information.

Moreover, in the case that the changed model generating unit 120 can not generate a changed security requirement model, the changed model generating unit 120 may output information which indicates that generation of the changed security requirement model is failed. Here, the case that generation of the changed security requirement model is failed is caused, for example, in the case that the record 831 including the function name, which is identical with the function name included in the security requirement model 810, cannot be acquired.

Returning to explanation of FIG. 7, as a next step, the work extracting unit 130 checks whether the judgment result of the model change judging unit 110 is ‘core configuration element’ or ‘not’ (S605).

In the case of ‘core configuration element’ (YES in S605), the work extracting unit 130 extracts the security work element which is included in the changed security requirement model, and outputs the extracted security work element (S606). Then, the process ends.

In the case of ‘not’ (NO in S605), the process ends.

The above is a description on the operation of the security design device 100.

The security design device 100 receives the configuration change information, for example, from a monitoring apparatus (not shown in the figure) which monitors a working state of each configuration element of the target system, and outputs the extracted security work element to a configuration control apparatus (not shown in the figure) which controls the configuration of the target system.

On the basis of the received security work element, the configuration control apparatus may add an authentication domain and register identification authentication information of an AP server (not shown in the figure) for adding the AP server newly to an authentication server (not shown in the figure) or changing the AP server in the authentication server. On the basis of the received security work element, the configuration control apparatus may set an IP address of the authentication server to the AP server, and may set an authentication domain to the AP server when changing from the local authentication to the LDAP authentication.

Here, the security design device 100 may output the extracted security work element to the output unit 705. In this case, for example, an operator may carry out each setting work on the basis of the security work element.

Moreover, the security design device 100 receives the configuration change information from the input unit 704, and displays the extracted security work element by use of the output unit 705. In this case, the security design device 100 may output either or both of the security requirement model 810 and the changed security requirement model. Moreover, the security design device 100 may output information indicating ‘core component’ or ‘not’ which is the judgment result of the model change judging unit 110.

A first advantage in the present exemplary embodiment is in a point that, even when the first core configuration element for implementing the security function has become unusable, it is possible to maintain the security which existed before the loss of the core configuration element.

The reason is that the exemplary embodiment includes the following configuration. Firstly, the model change judging unit 110 judges whether the first configuration element is ‘core configuration element’ or ‘not’. Secondly, the changed model generating unit 120 generates the changed security requirement model, and the work extracting unit 130 extracts and outputs the security work element.

A second advantage in the exemplary embodiment mentioned above is in a point that it is possible to automate maintenance of the security.

The reason is that the security design device 100 receives the configuration change information from the monitoring apparatus which monitors the working state of each configuration element of the target system, and outputs the extracted security work element to the configuration control apparatus which controls the configuration of the target system.

That is, the reason is that the configuration control apparatus receives the security work element, and can add or change various setting.

A third advantage in the exemplary embodiment mentioned above is in a point that it is possible to verify reliability of the security maintenance in the target system.

The reason is that the exemplary embodiment includes the following configuration. Firstly, in the case that the changed security requirement model can be generated, the work extracting unit 130 outputs the security work element. Secondly, in the case that the changed security requirement model can not be generated, the changed model generating unit 120 outputs the information which indicates that generation of the changed security requirement model is failed.

### Second Exemplary Embodiment

Next, a second exemplary embodiment of the present invention will be described in detail with reference to a drawing. Hereinafter, description which overlaps with the above description is omitted as far as description on the exemplary embodiment does not become obscure.

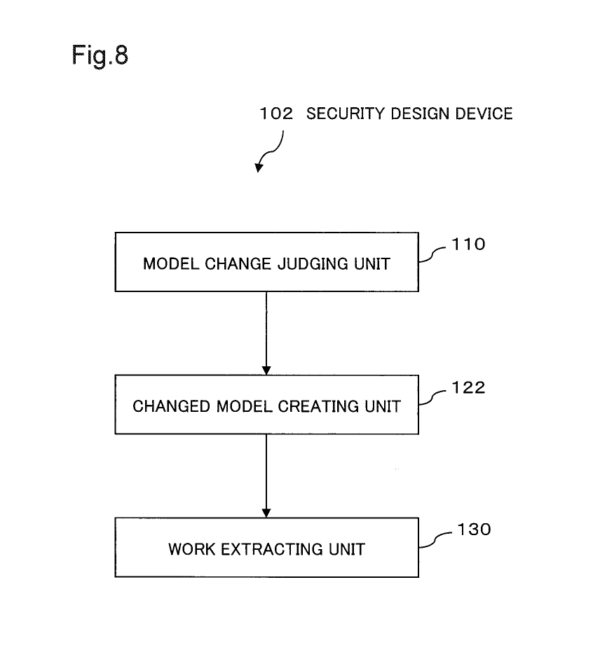

FIG. 8 is a block diagram showing a configuration of a second design device 102 according to the second exemplary embodiment of the present invention.

Referring to FIG. 8, the security design device 102 of the second exemplary embodiment includes a changed model generating unit 122 in place of the changed model generating unit 120 in comparison with the security design device 100 of the first exemplary embodiment.

===Changed Model Generating Unit 122===

In the case that the judgment result of the model change judging unit 110 is ‘core configuration element’, the changed model generating unit 122 of the exemplary embodiment generates a changed security requirement model whose definition is different from definition of the changed security requirement model generated by the changed model generating unit 120. The changed security requirement model is a security requirement model which implements the security function for the second configuration element without using the first configuration element. The security function is a security function which is the same as when using the first configuration and which is implemented with an implementation method which is the same as when using the first component.

Specifically, with reference to the security function information 830, the changed model generating unit 122 acquires the record 831 including a function name and an implementation method which are the same as the function name and the implementation method included in the security requirement model 810 respectively.

Accordingly, in the case that the changed model generating unit 122 receives the security requirement model 810 and the judgment result (for example, ‘authentication server 1: core configuration information’), there is no case that the changed model generating unit 122 acquires the record 832 shown in FIG. 4.

The operation of the changed model generating unit 122 except for the above mention is the same as the operation of the changed model generating unit 120.

The exemplary embodiment has the same advantage as the first exemplary embodiment has, and furthermore has an advantage in a point that, even when the first core configuration element for implementing the security function has become unusable, it is possible to maintain the security, which existed before the loss of the core configuration element, with the same implementation method.

The reason is that the changed model generating unit 122 generates the changed security requirement model for the second configuration element without using the first configuration element. With the same implementation method as when using the first configuration, the changed security requirement model implements the same security function as when using the first configuration.

### Third Exemplary Embodiment

Next, a third exemplary embodiment of the present invention will be described in detail with reference to a drawing. Hereinafter, description which overlaps with the above description is omitted as far as description on the exemplary embodiment does not become obscure.

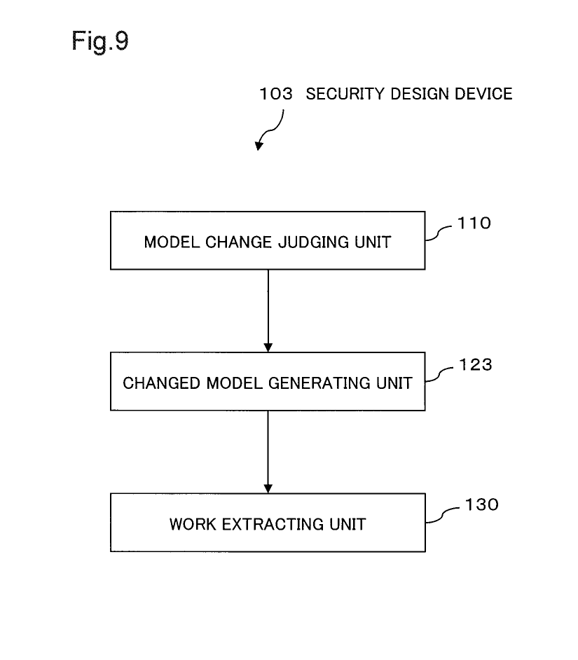

FIG. 9 is a block diagram showing a configuration of a security design device 103 according to the third exemplary embodiment of the present invention.

Referring to FIG. 9, the security design device 103 of the third exemplary embodiment includes a changed model generating unit 123 in place of the changed model generating unit 120 in comparison with the security design device 100 of the first exemplary embodiment.

===Changed Model Generating Unit 123===

In the case that the judgment result of the model change judging unit 110 is ‘core configuration element’, the changed model generating unit 123 of the exemplary embodiment generates a changed security requirement model whose definition is different from definition of the changed security requirement model generated by the changed model generating unit 120. The changed security requirement model is a security requirement model which implements the security function for the second component. The security function is carried out without using the first configuration element, and a security level exists within a specific range from a security level which is implemented in the case of using the first configuration, and the security function is the same as when using the first configuration.

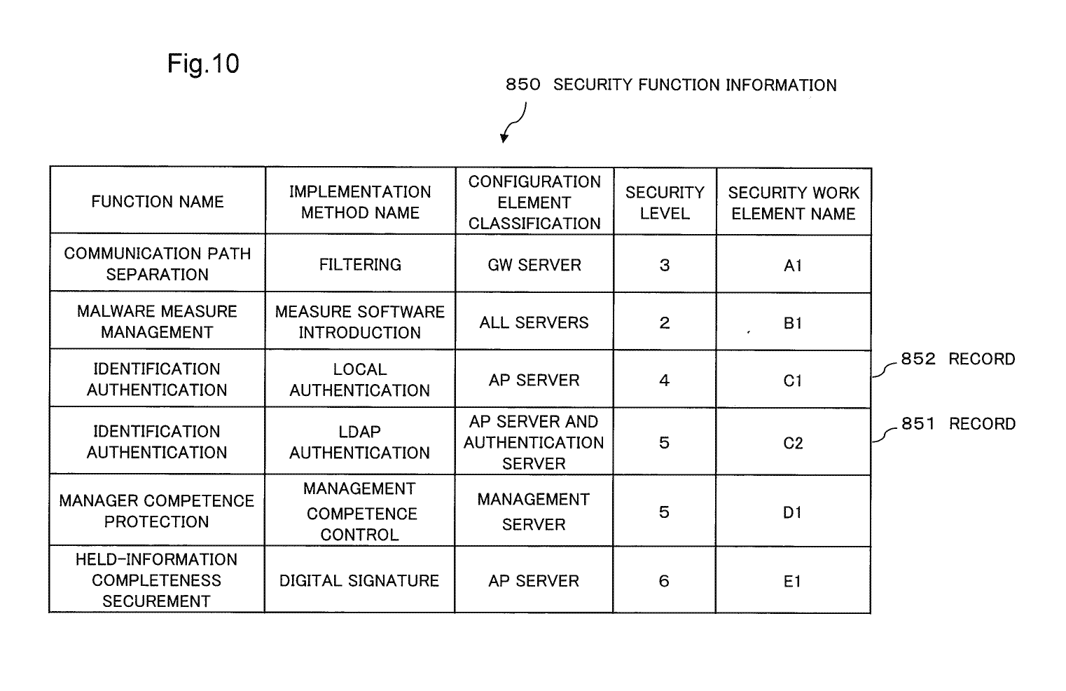

FIG. 10 is a diagram showing an example of security function information 850 in the exemplary embodiment. Referring to FIG. 10, the security function information 850 includes furthermore the security level which is corresponding to the function name and the implementation method name.

The security level is expressed, for example, by natural number, and becomes high (security is strong) as the natural number becomes large. Here, the security level is not limited to the above. The security level may be expressed optionally (for example, ‘high, medium, and low’).

Specifically, with reference to the security function information 850, the changed model generating unit 123 acquires a record 851. The record 851 includes a function name which is identical with the function name included in the security requirement model 810, and a value of security level which is larger than a value of security level of the security requirement model 810. The changed model generating unit 123 defines the security level of the record 851 including the configuration element classification identifier which is corresponding to the configuration element identifier, the implementation method name, and the function name of the security requirement model 810 as the value of the security level of the security requirement model 810.

In this case, there is no case that the changed model generating unit 123 acquires a record 852 in the case that the changed model generating unit 123 receives the security requirement model 810 and the judgment result (for example, ‘authentication server 1: core configuration information’).

Moreover, the changed model generating unit 123 may acquire the record 851, for example, with reference to the security function information 830. The record 851 includes a function name which is the same as the function name included in the security requirement model 810, and a value of security level whose difference from the value of security level of the security requirement model 810 is not larger than 2.

In this case, there is a case that the changed model generating unit 123 acquires the record 852 in the case that the changed model generating unit 123 receives the security requirement model 810 and the judgment result (for example, ‘authentication server 1: core configuration information’)

The operation of the changed model generating unit 123 except for the above is the same as the operation of the changed model generating unit 120.

The exemplary embodiment has the same advantage as the first exemplary embodiment has, and furthermore has an advantage in a point that, even when the first core configuration element for implementing the security function has become unusable, it is possible to maintain the security level which existed before the loss of the core configuration element. That is, it is possible to maintain the security level which existed before the loss of the core configuration element so that the security level may be within the specific range from the security level which is implemented in the case of using the first configuration element.

The reason is that the changed model generating unit 123 generates the changed security requirement model for the second configuration element. Without using the first configuration element, the changed security requirement model implements the security function which is the same as when using the first configuration and whose security level is within the specific range from the security level which is implemented when using the first configuration.

### Fourth Exemplary Embodiment

Next, a fourth exemplary embodiment of the present invention will be described in detail with reference to a drawing. Hereinafter, description which overlaps with the above description is omitted as far as description on the exemplary embodiment does not become obscure.

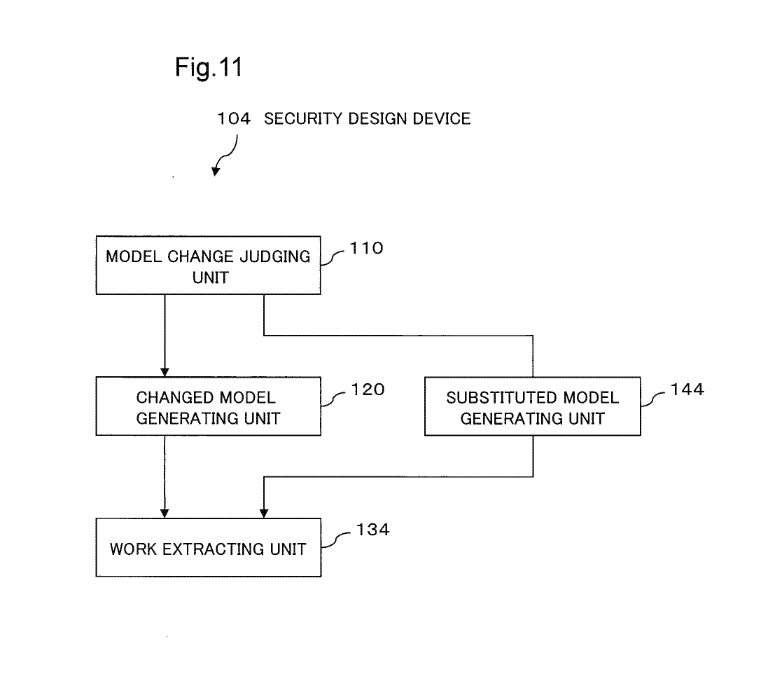

FIG. 11 is a block diagram showing a configuration of a security design device 104 according to the fourth exemplary embodiment of the present invention.

Referring to FIG. 11, the security design device 104 of the exemplary embodiment includes furthermore a substituted model generating unit 144 in comparison with the security design device 100 of the first exemplary embodiment. The security design device 104 includes a work extracting unit 134 in place of the work extracting unit 130 in comparison with the security design device 100 of the first exemplary embodiment.

===Substituted Model Generating Unit 144===

In the case that the judgment result of the model change judging unit 110 is ‘not (first configuration element is not core configuration element)’, the substituted model generating unit 144 generates a substituted security requirement model by use of the system configuration element information 840, and outputs the substituted security requirement model which is generated. The substituted security requirement model is a security requirement model which is acquired by replacing the first configuration element (for example, AP server 11) with a configuration element for substitution (for example, AP server 13).

===Work Extracting Unit 134===

In the case that the judgment result of the model change judging unit 110 is ‘core configuration element (first configuration element is core configuration element)’, the work extracting unit 134 extracts a security work element which is included in the changed security requirement model, and outputs the extracted security work element. Moreover, in the case that the judgment result of the model change judging unit 110 is ‘not’, the work extracting unit 134 extracts a security work element which is included in the substituted security requirement model, and outputs the extracted security work element.

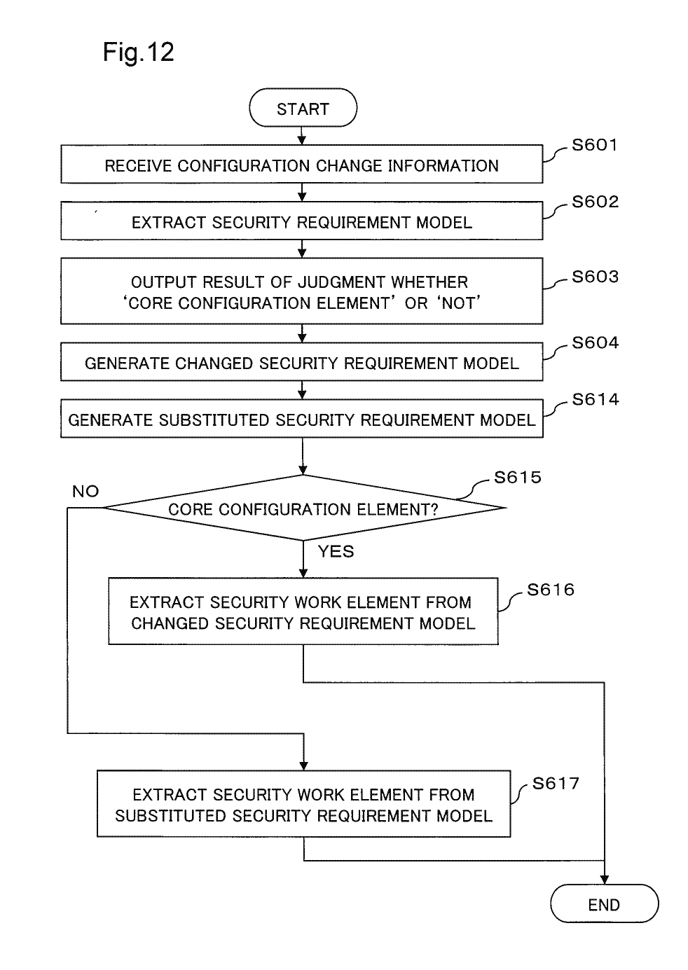

Next, an operation of the exemplary embodiment will be described in detail with reference to FIG. 11 and FIG. 12.

FIG. 12 is a flowchart showing the operation of the exemplary embodiment. Here, processes defined in the flowchart may be carried out on the basis of the above-mentioned program control by CPU 701. Moreover, a step name of the process is denoted as a symbol like S601.

The operation of Step S601 to Step S604 is the same as the operation shown in FIG. 7.

Next, the substituted model generating unit 144 generates a substituted security requirement model on the basis of the received judgment result by use of the system configuration element information 840 and outputs the substituted security requirement model (S614). Here, in the case that the judgment result which the model change judging unit 110 outputs is ‘core configuration element’, the substituted model generating unit 144 may carry out no process.

Next, the work extracting unit 134 checks whether the judgment result of the model change judging unit 110 is ‘core configuration element’ or ‘not’ (S615).

In the case of ‘core configuration element’ (YES in S615), the work extracting unit 134 extracts a security work element which is included in the changed security requirement model, and outputs the extracted security work element (S616). Then, the process ends.

In the case of “not” (NO in S615), the work extracting unit 134 extracts a security work element which is included in the substituted security requirement model, and outputs the extracted security work element (S617). Then, the process ends.

The exemplary embodiment has the same advantage as the first exemplary embodiment has, and furthermore has an advantage in a point that, even when the first configuration element is not ‘core configuration element’, it is possible to extract the security work element related to the first configuration element, and outputs the extracted security work element.

The reason is that the substituted model generating unit 144 generates the substituted security requirement model, and the work extracting unit 134 extracts the security work element which is included in the substituted security requirement model, and outputs the extracted security work element.

### Fifth Exemplary Embodiment

Next, a fifth exemplary embodiment of the present invention will be described in detail with reference to a drawing. Hereinafter, description which overlaps with the above description is omitted as far as description on the exemplary embodiment does not become obscure.

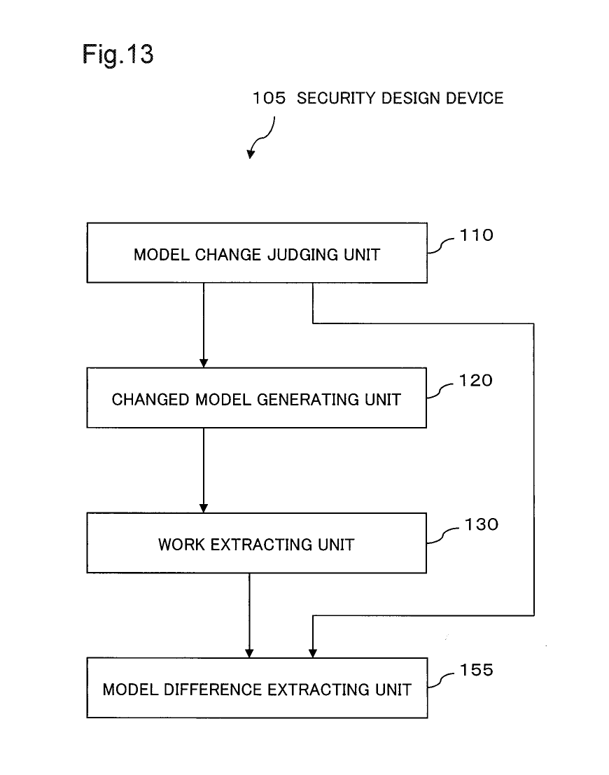

FIG. 13 is a block diagram showing a configuration of a security design device 105 according to the fifth exemplary embodiment of the present invention.

Referring to FIG. 13, the security design device 105 in the exemplary embodiment includes furthermore a model difference extracting unit 155 in comparison with the security design device 100 of the first exemplary embodiment.

===Model Difference Extracting Unit 155===

The model difference extracting unit 155 extracts a difference between the security work element which the work extracting unit 130 extracts, and the security work element of the security requirement model 810 which the model change judging unit 110 extracts, and outputs the extracted difference. That is, the model difference extracting unit 155 extracts the difference in the security work element between the changed security requirement model and the security requirement model 810, and outputs the extracted difference.

Here, the security design device 105 may include the work extracting unit 134 in place of the work extracting unit 130. In this case, the model difference extracting unit 155 may extract a difference between the security work element which the work extracting unit 134 extracts, and the security work element of the security requirement model 810 which the model change judging unit 110 extracts, and output the extracted difference. That is, the model difference extracting unit 155 may extract a difference between the security work element of the changed security requirement model and the substituted security requirement model, and the security work element of the security requirement model 810, and output the extracted difference.

The exemplary embodiment mentioned above has the same advantage as the first exemplary embodiment has, and furthermore has an advantage in a point that it is possible to make a process of returning from the changed security requirement model and the substituted security requirement model to the security requirement model 810 easy.

The reason is that the model difference extracting unit 155 extracts the difference between the security work element of the changed security requirement model and the substituted security requirement model, and the security work element of the security requirement model 810, and outputs the extracted difference.

### Sixth Exemplary Embodiment

Next, a sixth exemplary embodiment of the present invention will be described in detail with reference to a drawing. Hereinafter, description which overlaps with the above description is omitted as far as description on the exemplary embodiment does not become obscure.

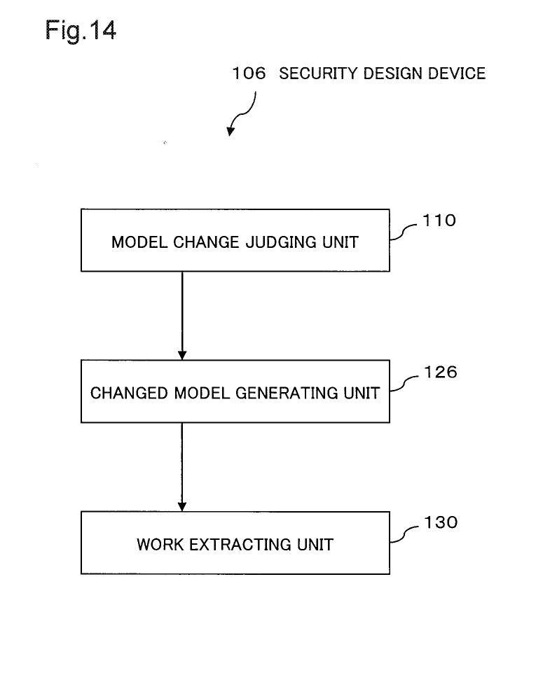

FIG. 14 is a block diagram showing a configuration of a security design device 106 according to the sixth exemplary embodiment of the present invention.

Referring to FIG. 14, the security design device 106 in the exemplary embodiment includes a changed model generating unit 126 in place of the changed model generating unit 120 in comparison with the security design device 100 of the first exemplary embodiment.

===Changed Model Generating Unit 126===

The changed model generating unit 126 generates a plurality of changed security requirement models, and selects one changed security requirement model out of the plural changed security requirement models, which are generated, on the basis of a requirement application judging rule, and outputs the changed security requirement model which is selected.

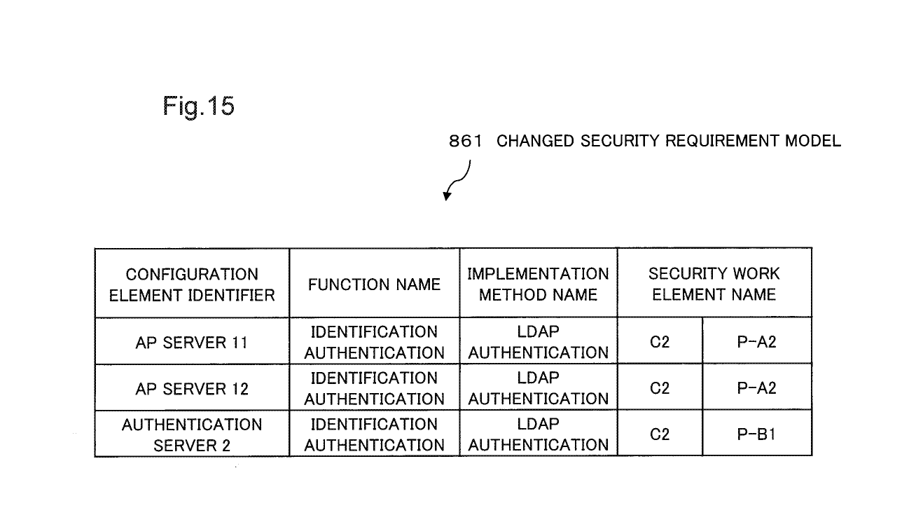

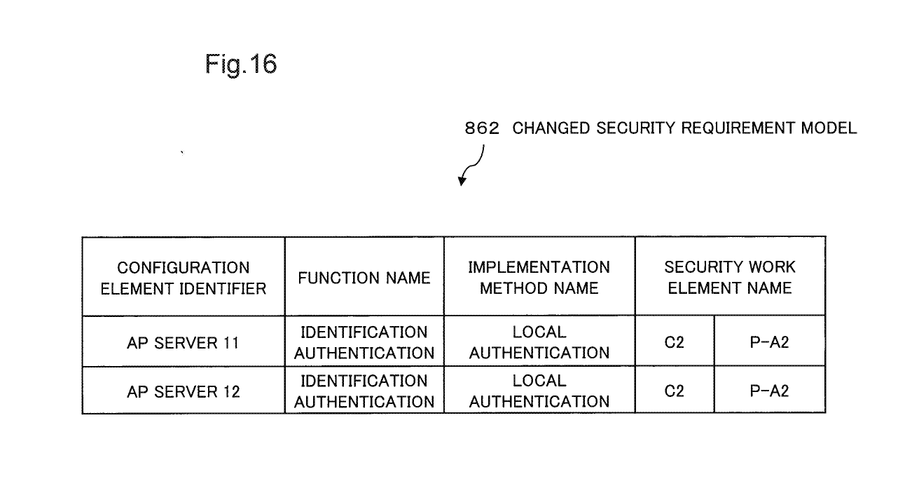

For example, the changed model generating unit 126 generates a first changed security requirement model and a second changed security requirement model similarly to the changed model generating unit 120. FIG. 15 is a diagram showing an example of the first changed security requirement model 861. FIG. 16 is a diagram showing an example of the second changed security requirement model 862.

For example, the requirement application judging rule is ‘to apply a model which makes degradation of the security level of the implementation method, which is caused when changing the security requirement model, minimum’. In this case, the changed model generating unit 126 selects the first changed security requirement model 861 on the basis of the security level which is included in the security function information 850 shown in FIG. 10, and outputs the first changed security requirement model 861 which is selected.

Moreover, the requirement application judging rule is ‘to apply a model which makes total number of configuration elements, each of which the change of the security requirement model causes a work element, minimum. In this case, the changed model generating unit 126 selects the second changed security requirement model 862 on the basis that number of the configuration elements of the first changed security requirement model 861 is 3, and number of the configuration elements of the second changed security requirement model 862 is 2.

Further, the requirement application judging rule is not limited to the above-mentioned example. The requirement application judging rule may be an optional rule. Moreover, the security design device 106 may select the changed security requirement model by using a plurality of requirement application judging rules in an order of priority.

For example, the security design device 106 holds the requirement application judging rule in advance. Or, the security design device 106 may acquire the requirement application judging rule from the input unit 704.

The exemplary embodiment mentioned has the same advantage as the first exemplary embodiment has, and furthermore has an advantage in a point that it is possible to select the changed security requirement model more appropriately.

The reason is that the changed model generating unit 126 generates a plurality of changed security requirement models, and selects one changed security requirement model out of the plural changed security requirement models, which are generated, on the basis of the requirement application judging rule, and outputs the changed security requirement model which is selected.

### Seventh Exemplary Embodiment

Next, a seventh exemplary embodiment of the present invention will be described in detail with reference to a drawing. Hereinafter, description which overlaps with the above description is omitted as far as description on the exemplary embodiment does not become obscure.

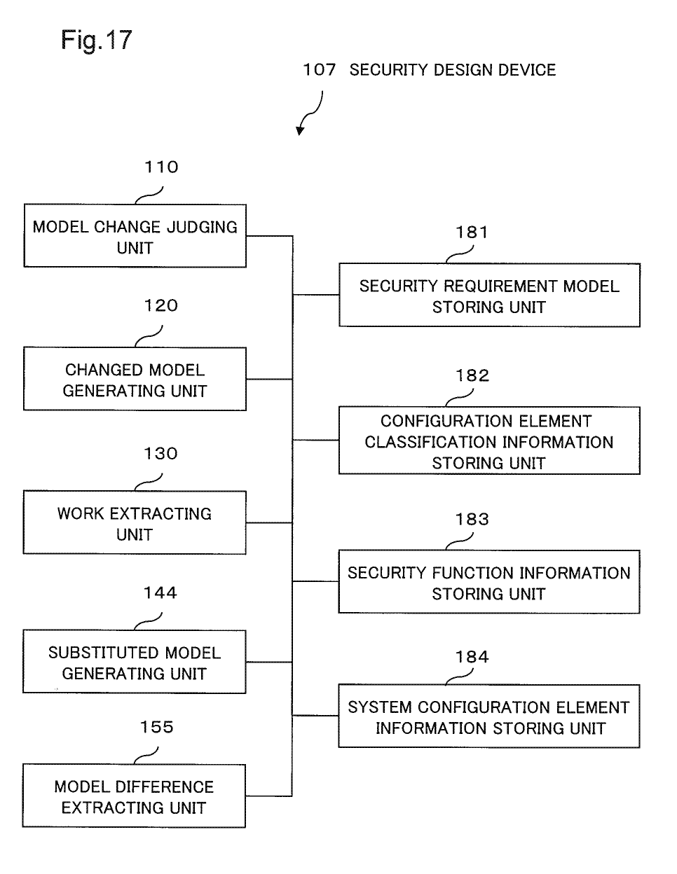

FIG. 17 is a block diagram showing a configuration of a security design device 107 according to the seventh exemplary embodiment of the present invention.

Referring to FIG. 17, the security design device 107 in the exemplary embodiment includes the model change judging unit 110, the changed model generating unit 120, the work extracting unit 130, the substituted model generating unit 144 and the model difference extracting unit 155. Moreover, the security design device 107 includes furthermore a security requirement model storing unit 181, a configuration element classification information storing unit 182, a security function information storing unit 183 and a system configuration element information storing unit 184. Here, the security requirement model storing unit 181, the configuration element classification information storing unit 182, the security function information storing unit 183 and the system configuration element information storing unit 184 may include the storage unit 702 or the storage device 703 as a part.

The model change judging unit 110 is the same as the model change judging unit 110 shown in FIG. 1. The changed model generating unit 120 is the same as the changed model generating unit 120 shown in FIG. 1. The work extracting unit 130 is the same as the work extracting unit 130 shown in FIG. 1. The substituted model generating unit 144 is the same as the substituted model generating unit 144 shown in FIG. 11. The model difference extracting unit 155 is the same as the model difference extracting unit 155 shown in FIG. 13.

The security requirement model storing unit 181 stores the security requirement model 810. The configuration element classification information storing unit 182 stores the configuration element classification information 820. The security function information storing unit 183 stores the security function information 830. The system configuration element information storing unit 184 stores the system configuration element information 840.

Here, the security design device 107 may include the changed model generating unit 122 shown in FIG. 8, the changed model generating unit 123 shown in FIG. 9 or the changed model generating unit 126 shown in FIG. 14 in place of the changed model generating unit 120. Moreover, the security design device 107 may include the work extracting unit 134 in place of the work extracting unit 130.

An advantage in the exemplary embodiment mentioned above is in a point that it is possible to obtain the advantages of the first to the sixth exemplary embodiments optionally.

The reason is that the exemplary embodiment is corresponding to an optional combination among the elements of the first to the sixth exemplary embodiments.

It is not always necessary that each configuration element exists independently. For example, each configuration element may be implemented so that a plurality of configuration elements may compose one module. Moreover, each configuration element may be implemented so that one configuration element may compose a plurality of modules. Moreover, each configuration element may be configured so that one configuration element may be a part of another configuration element. Moreover, each configuration element may be configured so that a part of one configuration element may overlap with a part of another configuration element.

Each configuration element, and the module which implements each configuration element may be implemented in a form of hardware if necessary and if possible. Moreover, each configuration element, and the module which implements each configuration element may be implemented by a computer and program. Moreover, each configuration element, and the module which implements each configuration element may be implemented by a combination of a hardware module, and the computer and program.

The program is recorded in a non-transitory computer-readable recording medium such as a magnetic disk, a semiconductor memory or the like to be provided. The program is read by a computer when activating the computer. The read program controls an operation of the computer, and consequently the program makes the computer work as the configuration element in each exemplary embodiment mentioned above.

Moreover, while a plurality of operations are described in turn in a form of the flowchart according to each exemplary embodiment described above, the turn in the description does not limit a turn of executing the plural operations. For this reason, when carrying out each exemplary embodiment, it is possible to change the turn of executing the plural operations as far as not causing a fault substantially.

Moreover, according to each exemplary embodiment described above, a plurality of operations are not limited to being carried out at points of time which are different each other. For example, while one operation is being executed, another operation may be activated, and execution timing of one operation may overlap with execution timing of another operation partially or whole.

Furthermore, while it is described in each exemplary embodiment described above that one operation activates another operation, the description does not limit all relations between one operation and another operation. For this reason, when carrying out each exemplary embodiment, it is possible to change the relation among the plural operations as far as not causing a fault substantially. Moreover, the specific description on the operation of each configuration element does not limit each operation of each configuration element. For this reason, each specific operation of each configuration element may be changed as far as not causing a fault to the function, the performance and the other characteristics when carrying out each exemplary embodiment.

While the present invention has been described with reference to each exemplary embodiment mentioned above, the present invention is not limited to the above-mentioned exemplary embodiment. It is possible to add various modifications, which a person skilled in the art can understand, to the composition and the details of the present invention within the scope of the present invention.

### INDUSTRIAL APPLICABILITY

The present invention can be applied to an apparatus which supports planning, verification, evaluation and improvement in security design of an information processing system.

### REFERENCE SIGNS LIST

100 security design device
102 security design device
103 security design device
104 security design device
105 security design device
106 security design device
107 security design device
110 model change judging unit
120 changed model generating unit
122 changed model generating unit
123 changed model generating unit
126 changed model generating unit
130 work extracting unit
134 work extracting unit
144 substituted model generating unit
155 model difference extracting unit
181 security requirement model storing unit
182 configuration element classification information storing unit
183 security function information storing unit
184 system configuration element information storing unit
700 computer
701 CPU
702 storage unit
703 storage device
704 input unit
705 output unit
706 communication unit
707 recording medium
810 security requirement model
811 security requirement model record
820 configuration element classification information
830 security function information
831 record
832 record
840 system configuration element information
841 record
850 security function information
851 record
852 record
861 changed security requirement model
862 changed security requirement model

What is claimed is:

1-8. (canceled)

9. A security design device, comprising:
a model change judging unit which receives configuration change information, which includes identification information of a first configuration element included in a target system, from the outside, and
for extracting a security requirement model, which is corresponding to the identification information of the first configuration element, from a set of security requirement models including one or more security requirement model records including at least configuration element identification information, security function identification information, security function implementation method identification information and security work element identification information which are related to a security function of the target system, and for outputting the extracted security requirement model, and
for judging, by use of configuration element classification information indicating that a configuration element is ‘core configuration element’, which implements a security function of another configuration element, or ‘not’, in an implementation method of a security function which is specified by the security function identification information and the security function implementation method identification information, whether the first configuration element is ‘core configuration element’, which implements a security function of a second configuration element other than the first configuration element, or ‘not’ in the extracted security requirement model, and for outputting the judgment result;
a changed model generating unit which uses information, which indicates a relation among identification information, an implementation method, a configuration element classification and a security work element of the security function, and information on a configuration element of the target system, and for generating a changed security requirement model corresponding to a security requirement model which, without using the first configuration element, implements a security function, which is the same as when the first configuration element is used, for the second configuration element, and for outputting the changed security requirement model which is generated, in the case that the judgment result of the model change judging unit is that the first configuration element is ‘core configuration element’; and
a work extracting unit which extracts the security work element of the changed security requirement model and for outputting the extracted security work element.

10. The security design device according to claim 9, characterized in that:
the changed model generating unit generates a changed security requirement model corresponding to a security requirement model which, with the same implementation method as when the first configuration is used, implements the same security function as when the first configuration is used, and outputs the changed security requirement model which is generated.

11. The security design device according to claim 9, characterized in that:
the security function information indicates a relation among the identification information, the implementation method, the configuration element classification, the security work element, and a security level indicating a height of security which are related to the security function; and
the changed model generating unit generates a changed security requirement model corresponding to a security requirement model implementing a security function whose security level exists within a specific range from a security level implemented when the first configuration is used and which is the same as when the first configuration is used, and outputs the changed security requirement model which is generated.

12. The security design device according to claim 9, characterized by further comprising:
a substituted model generating unit which uses information on a configuration element of the target system, and for generating a substituted security requirement model corresponding to a security requirement model, which is acquired by replacing the first configuration element with a configuration element for substitution, and for outputting the substituted security requirement model which is generated, in the case that the judgment result of the model change judging unit is ‘not’, wherein
the work extracting unit extracts the security work element of the changed security requirement model in the case that the judgment result of the model change judging unit is that the first configuration element is ‘core configuration element’, and extracts the security work element of the substituted security requirement model in the case that the judgment result is ‘not’, and outputs the extracted security work element.

13. The security design device according to claim 9, characterized by further comprising:
a model difference extracting unit which extracts a difference between a security work element of the changed security requirement model and the substituted security requirement, and a security work element of a security requirement model which is extracted by the model change judging unit, and for outputting the extracted difference.

14. The security design device according to claim 9, characterized in that:
the changed model generating unit generates a plurality of the changed security requirement models, and selects one changed security requirement model out of the plural security requirement models on the basis of a requirement application judging rule, and outputs the changed security requirement model which is selected.

15. A security design method, wherein
a computer:
receives configuration change information, which includes identification information of a first configuration element included in a target system, from the outside;
extracts a security requirement model, which is corresponding to the identification information of the first configuration element, from a set of security requirement models including one or more security requirement model records including at least configuration element identification information, security function identification information, security function implementation method identification information and security work element identification information which are related to a security function of the target system, and outputting the extracted security requirement model;
judges, by use of configuration element classification information indicating that a configuration element is ‘core configuration element’, which implements a security function of another configuration element, or ‘not’, in an implementation method of a security function which is specified by the security function identification information and the security function implementation method identification information, whether the first configuration element is ‘core configuration element’, which implements a security function of a second configuration element other than the first configuration element, or ‘not’ in the extracted security requirement model, and outputting the judgment result;
uses information, which indicates a relation among identification information, an implementation method, a configuration element classification and a security work element of the security function, and information on a configuration element of the target system, and generating a changed security requirement model corresponding to a security requirement model which, without using the first configuration element, implements a security function, which is the same as when the first configuration element is used, for the second configuration element, and outputting the changed security requirement model which is generated, in the case that the first configuration element is ‘core configuration element’; and
extracts the security work element of the changed security requirement model, and outputting the extracted security work element.

16. A non-transitory computer-readable recording medium which records a program to make a computer execute process of:
receiving configuration change information, which includes identification information of a first configuration element included in a target system, from the outside;
extracting a security requirement model, which is corresponding to the identification information of the first configuration element, from a set of security requirement models including one or more security requirement model records including at least configuration element identification information, security function identification information, security function implementation method identification information and security work element identification information which are related to a security function of the target system, and outputting the extracted security requirement model;
judging, by use of configuration element classification information indicating that a configuration element is ‘core configuration element’, which implements a security function of another configuration element, or ‘not’, in an implementation method of a security function which is specified by the security function identification information and the security function implementation method identification information, whether the first configuration element is ‘core configuration element’, which implements a security function of a second configuration element other than the first configuration element, or ‘not’ in the extracted security requirement model, and outputting the judgment result;
using information, which indicates a relation among identification information, an implementation method, a configuration element classification and a security work element of the security function, and information on a configuration element of the target system, and generating a changed security requirement model corresponding to a security requirement model which, without using the first configuration element, implements a security function, which is the same as when the first configuration element is used, for the second configuration element, and outputting the changed security requirement model which is generated, in the case that the first configuration element is ‘core configuration element’; and
extracting the security work element of the changed security requirement model, and outputting the extracted security work element.
